(19) United States
(12) Patent Application Publication
(10) Pub. No.: US 2025/0378368 A1
(43) Pub. Date: Dec. 11, 2025

(54) SYSTEMS AND METHODS FOR GENERATING IMPROVED TRAINING DATA FOR MACHINE LEARNING APPLICATIONS

(71) Applicant: Optum, Inc., Minnetonka, MN (US)

(72) Inventors: Sudhanshu SHARMA, Basavanagar (IN); Ayan SENGUPTA, Noida (IN); Julie ZHU, Maple Grove, MN (US); Abhishek VERMA, Sugar Land, TX (US)

(21) Appl. No.: 18/737,277

(22) Filed: Jun. 7, 2024

(51) Int. Cl. G06N 20/00

(52) U.S. Cl. CPC G06N 20/00

(57) ABSTRACT

Systems and methods are disclosed for generating training data for a machine learning model. The method includes receiving, from one or more data sources, a first machine learning training data set that includes a plurality of data points; determining an input outlier score of a first data point of the plurality of data points; determining an output outlier score of the first data point; generating a total output score of the first data point based on the input outlier score of the first data point and the output outlier score of the first data point, the total output score of the first data point representing a likelihood that the first data point is an inconsistently annotated data point; comparing the total output score of the first data point with a pre-determined threshold; based on the comparison, generating a second machine learning training data set that excludes the first data point.

### TECHNICAL FIELD

The present disclosure relates generally to the field of data processing and predictive analytics. In particular, the present disclosure relates to processing data to detect inconsistent data annotations.

### BACKGROUND

In machine learning models, accurate predictive modeling relies on high-quality input and training datasets free or substantially free from inconsistent data annotations. Conventional methods for detecting inconsistent data annotations often involve outlier detection. Outliers, defined as data points that are significantly distant from the rest of the dataset, can distort the fitting process and compromise model performance. Conventional outlier detection methods, such as those based on statistical techniques, are insufficient for effectively handling the vast and intricate datasets common in machine learning applications.

Often, inconsistent data annotations are not identifiable by an input outlier detector or an output outlier detector. Consequently, conventional outlier detection algorithms fail to identify these inconsistencies, undermining the reliability of an input dataset or a training dataset. This, in turn, can lead to erroneous outputs from the machine learning models.

### SUMMARY OF THE DISCLOSURE

The present disclosure solves the technical challenges typically encountered during the use of a conventional method for identifying inconsistent data annotations, such as those discussed above. Specifically, the present disclosure solves the technical challenges by providing a centralized system that detects inconsistent data annotations in a joint input-output space.

In some embodiments, a computer-implemented method for generating training data for a machine learning model includes: receiving, by one or more processors and from one or more data sources, a first machine learning training data set that includes a plurality of data points; determining, by the one or more processors, an input outlier score of a first data point of the plurality of data points; determining, by the one or more processors, an output outlier score of the first data point; generating, by the one or more processors, a total output score of the first data point based on the input outlier score of the first data point and the output outlier score of the first data point, the total output score of the first data point representing a likelihood that the first data point is an inconsistently annotated data point; comparing, by the one or more processors, the total output score of the first data point with a pre-determined threshold; based on the comparison of the total output score of the first data point with the pre-determined threshold, generating, by the one or more processors, a second machine learning training data set that excludes the first data point; and inputting, by the one or more processors and into the machine learning model, the second machine learning training data set to train the machine learning model.

In some embodiments, a system for generating training data for a machine learning model includes: one or more processors of a computing system; and at least one non-transitory computer readable medium storing instructions which, when executed by the one or more processors, cause the one or more processors to: receive, from one or more data sources, a first machine learning training data set that includes a plurality of data points; determine an input outlier score of a first data point of the plurality of data points; determine an output outlier score of the first data point; generate a total output score of the first data point based on the input outlier score of the first data point and the output outlier score of the first data point, the total output score of the first data point representing a likelihood that the first data point is an inconsistently annotated data point; compare the total output score of the first data point with a pre-determined threshold; based on the comparison of the total output score of the first data point with the pre-determined threshold, generate a second machine learning training data set that excludes the first data point; and input, into the machine learning model, the second machine learning training data set to train the machine learning model.

In some embodiments, a non-transitory computer readable medium for generating training data for a machine learning model, the non-transitory computer readable medium storing instructions which, when executed by one or more processors of a computing system, causes the one or more processors to: receive, from one or more data sources, a first machine learning training data set that includes a plurality of data points; determine an input outlier score of a first data point of the plurality of data points; determine an output outlier score of the first data point; generate a total output score of the first data point based on the input outlier score of the first data point and the output outlier score of the first data point, the total output score of the first data point representing a likelihood that the first data point is an inconsistently annotated data point; compare the total output score of the first data point with a pre-determined threshold; based on the comparison of the total output score of the first data point with the pre-determined threshold, generate a second machine learning training data set that excludes the first data point; and input, into the machine learning model, the second machine learning training data set to train the machine learning model.

### BRIEF DESCRIPTION OF DRAWINGS

The accompanying drawings, which are incorporated in and constitute a part of this specification, illustrate various example embodiments and together with the description, serve to explain the principles of the disclosed embodiments.

FIG. 1 is a diagram showing an example of an environment for identifying inconsistent annotations in data objects, according to some embodiments of the disclosure.

FIG. 2 is a flow chart showing an example of a process for identifying inconsistent annotations in data objects, according to some embodiments of the disclosure.

FIG. 3 depicts an example document upon which the process of FIG. 2 is applied.

FIGS. 4A and 4B depict examples of data sets comprising a plurality of data points upon which the process of FIG. 2 is applied.

FIG. 5 depicts an example document upon which the process of FIG. 2 is applied.

FIG. 6 depicts an implementation of a computer system that executes techniques presented herein, according to some embodiments of the disclosure.

### DETAILED DESCRIPTION OF EMBODIMENTS

This present disclosure relates generally to the field of data processing and predictive analytics. In particular, the present disclosure relates to processing data to detect inconsistent data annotations.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the embodiments are not to be considered as limited by the foregoing description.

Various non-limiting embodiments of the present disclosure will now be described to provide an overall understanding of the principles of the structure, function, and use of systems and methods disclosed herein for analyzing data sets in a joint input-output space to identify inconsistent data annotations.

Conventional methods fail to reliably detect inconsistent data annotations, as some may not be readily identifiable as an input outlier and others may not be readily identifiable as an output outlier. It is technically challenging to develop methods that account for all types of inconsistent data annotations (e.g., in some instances, an inconsistent data annotation is overlooked because it does not register as an outlier using conventional methods).

For example, to determine inconsistent data annotations, conventional methods primarily utilize methods for determining outliers in the input space or outliers in the output space. However, some data points may be incorrectly annotated yet fail to be identified as either an input outlier or an output outlier by these conventional methods. Accordingly, these conventional methods have several drawbacks, such as: i) the usefulness of the data set as training data for a machine learning model is significantly limited, ii) inconsistent data annotations that are used to train machine learning algorithms cause erroneous outputs from the machine learning algorithms, and iii) mitigation actions after the erroneous outputs are identified are cumbersome and time-intensive. Further, even when an inconsistent data annotation is detected after the fact, it is difficult to determine the root cause of the error.

The present disclosure provides embodiments that address the above shortcomings in the field of data processing and predictive analytics, leading to significant technical improvements in the same field. For instance, system 110 discussed in the present disclosure overcomes the technical shortcomings of the conventional techniques by determining a total outlier score for data annotations in a joint input-output space that overcomes the deficiencies in both input outlier detection algorithms and output outlier detection algorithms.

Advantageously, the system 110 implements a technique that allows for effective detection of inconsistent data annotations in a joint input-output space. To that end, the system 110 analyzes each data point in a data set in both an input space and an output space and then determines if the data point may be inconsistent in its annotations by determining an input outlier score for the data point, an output outlier score for the data point, and a total outlier score for the data point based on the input outlier score and the output outlier score.

In one embodiment, the system 110 receives one or more datasets (e.g., a control dataset, a system dataset, a non-system dataset, etc.) from a plurality of data sources. The system 110 determines an input outlier score of a first data point of the plurality of data points in one or more of the datasets, determines an output outlier score of the first data point, determines a total outlier score of the first data point based on the input outlier score of the first data point and the output outlier score of the first data point, and upon determining that the total outlier score of the first data point exceeds a pre-determined threshold, determines that the data point is incorrectly annotated. The system 110 compares at least one of total outlier score or a total output score based on the total outlier score with a pre-determined threshold to determine whether to initiate performance of one or more mitigation actions. In such a manner, the system 110 identifies an inconsistent data annotation and prevents the inconsistent data annotation from being used in, for example, a training data set.

The above technical improvements, and additional technical improvements, will be described in detail throughout the present disclosure. Also, it should be apparent to a person of ordinary skill in the art that the technical improvements of the embodiments provided by the present disclosure are not limited to those explicitly discussed herein, and that additional technical improvements exist. The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

In many supervised learning classification problems, a target, e.g., an outcome that is to be predicted by the supervised machine learning model, is categorical in nature, meaning that the prediction is one of a class of possible outcomes based on one or more input features. The class may be binary (where the class of possible outcomes includes exactly two outcomes), or the class may include two or more possible outcomes, e.g., is multiclass.

Supervised machine learning models often rely on annotated training data, where a human or machine annotator applies a label to a set of input features. The model than relies on these labels when making predictions of new targets based on new input features. It is thus imperative to confirm that the annotated data is reasonably free from annotation errors.

Creating ground truths for a supervised machine learning model is an expensive, laborious, and time-consuming task. The process of labeling and annotating data requires contextual understanding and application of prior domain knowledge and heuristics. If the input features of two records within a data set are similar, the determined output of the input features, e.g. the outcome, should likely be the same. Any data points not following this phenomenon are referred to as outliers.

Outlier detection is a statistical procedure that aims to find data points that deviate from the normal form of a dataset. There are two general types of outlier detection: global outlier detection and local outlier detection. Global outliers fall outside the normal range for an entire dataset, whereas local outliers may fall within the normal range for the entire dataset, but outside the normal range determined by the surrounding data points. Local outlier detection is used in the present disclosure to identify labels which are outliers. These outliers may advantageously be excluded from training data sets to improve the machine learning classification model performance.

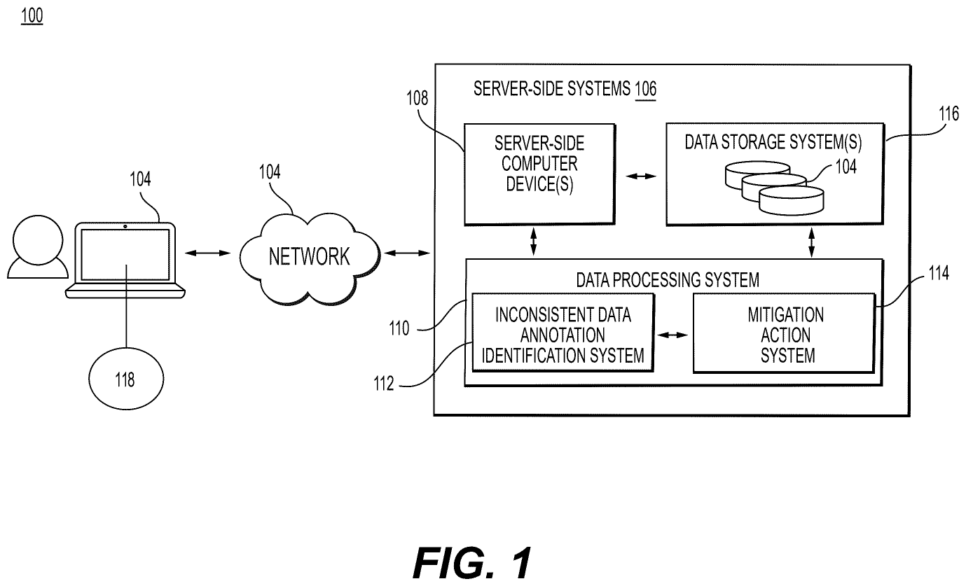

FIG. 1 is a diagram showing an example of an environment 100 for detecting inconsistent data annotations, according to some embodiments of the disclosure. A client device 102 associated with a user communicates with one or more other components of the environment 100 across a network 104, including one or more server-side systems 106. The server-side systems 106 may be local or remote file servers, cloud-based storage services, or other forms of computer systems.

The server-side systems 106 include server-side computing device(s) 108, a data processing system 110, and/or one or more data storage system(s) 116, among other systems. In some examples, the data processing system 110 includes an inconsistent data annotation identification system 112 and a mitigation action system 114. The data storage system(s) 116 include one or more data stores.

In some examples, the server-side computing device(s) 108, the data processing system 110, and/or the data storage system(s) 116 are associated with a common entity and are part of a cloud service computer system (e.g., in a data center). That is, the various systems can be components or subsystems of a larger computer system. In other examples, one or more of the server-side computing device(s) 108, the data processing system 110, and/or the data storage system(s) 116 are separate systems associated with different entities. In such examples, each of the separate systems are communicatively connected to one another over the network 104 (e.g., via an application programming interface (API)). The systems and devices of the environment 100 can communicate in any arrangement. As discussed herein, systems and/or devices of the environment 100 communicate in order to facilitate processing of data objects, particularly the identification of inconsistent data annotations and mitigating actions taken in response to the identification of inconsistent data annotations.

The client device 102 is configured to enable the user to access and/or interact with other systems in the environment 100. In some examples, the user is associated with (e.g., is an employee or contractor of) the entity. The client device 102 is a computer system such as, for example, a desktop computer, a laptop computer, a tablet, a smart cellular phone, a smart watch, or other wearable computer, etc. The client device 102 includes one or more applications, e.g., a program, plugin, browser extension, etc., installed on a memory of the client device 102. The applications can include one or more of system control software, system monitoring software, software development tools, etc.

In some embodiments, at least one of the applications is associated and configured to communicate with one or more of the other components in the environment 100, such as one or more of the server-side systems 106. For example, the at least one application 118 can be executed on the client device 102 to communicate with the server-side computing device(s) 108 to request generation of data objects or a list of data objects. The data objects are identified within the list based on metadata (e.g., a file name, a file property, a storage location) of the documents or other similar identifying information. The application can then process the data objects to determine if the data objects include any inconsistent data annotations, and give the user a list of inconsistent data annotations ordered by some priority useful to the user.

Additionally, one or more components of the client device 102, such as the at least one application, generate, or cause to be generated, one or more graphic user interfaces (GUIs) based on instructions/information stored in the memory, instructions/information received from the other systems in the environment 100, and/or the like and cause the GUIs to be displayed via a display of the client device 102. The GUIs can be, e.g., mobile application interfaces or browser user interfaces and include text, input text boxes, selection controls, and/or the like. In some examples, the display includes a touch screen or a display with other input systems (e.g., a mouse, keyboard, etc.) to control the functions of the client device 102.

The server-side computing device(s) 108 include one or more server devices (or other similar computing devices) for executing services associated with an entity. The services can include both user-facing services as well as internal services.

In some examples, the data processing system 110 is a system of (e.g., is hosted by) the same entity associated with the server-side computing device(s) 108. In such examples, the data processing system 110 can be a sub-system or component of the server-side computing device(s) 108. In other examples, the data processing system 110 is a system of (e.g., is hosted by) a third party that provides services for inconsistent data annotation identification to the entity associated with the server-side computing device(s) 108.

The inconsistent data annotation identification system 112 of the data processing system 110 includes one or more server devices (or other similar computing devices) for executing processes for identifying inconsistent data annotations. As described in detail elsewhere herein, example processes for identifying inconsistent data annotations include: receiving a first machine learning training data set from one or that includes a plurality of data points; determining an input outlier score of a first data point of the plurality of data points; determining an output outlier score of the first data point; generating a total outlier score of the first data point based on the input outlier score of the first data point and the output outlier score of the first data point; generating a total output score of the first data point based on the total outlier score of the first data point, the total output score of the first data point representing a likelihood that the first data point is an inconsistently annotated data point; comparing, by the one or more processors, the total output score of the first data point with a pre-determined threshold; based on the comparison, upon determining that the total outlier score of the first data point exceeds a pre-determined threshold, generating a second machine learning training data set that excludes the first data point, and inputting, into the machine learning model, the second machine learning training data set to train the machine learning model.

In some examples, the process may further include determining an input outlier score of a second data point of the plurality of data points, determining an output outlier score of the second data, generating a total output score of the second data point based on the input outlier score of the second data point and the output outlier score of the second data point, the total output score of the second data point representing a likelihood that the second data point is an inconsistently annotated data point, comparing the total output score of the second data point with the pre-determined threshold, based on the comparison of the total output score of the second data point with the pre-determined threshold, generating a third machine learning training data set that excludes the second data point, and inputting, into the machine learning model, the third machine learning training data set to train the machine learning model.

The mitigation action system 114 includes one or more server devices (or other similar computing devices) for executing mitigation actions. As described elsewhere herein, example processes performed by the mitigation action system 114 include: generating an alert indicating that one or more data points are inconsistently annotated data points as identified by the inconsistent data annotation identification system 112; or generating an updated training data set with the one or more data points removed.

The data storage system(s) 116 each include a server system or computer-readable memory such as a hard drive, flash drive, disk, etc. The data stores of the data storage system(s) 116 include and/or act as a repository or source for various types of data objects.

In some examples, one of the data storage system(s) 116 maintains each of the data stores. In other examples, one or more of the data stores are maintained across two or more different ones of the data storage system(s) 116. One or more of the data storage system(s) 116 can be a system of (e.g., hosted by) the same entity associated with the server-side computing device(s) 108 and/or data processing system 110. Additionally or alternatively, one or more of the data storage system(s) 116 are associated with a third party that provides data storage services to the entity and/or data processing system 110.

The network 104 over which the one or more components of the environment 100 communicate includes one or more wired and/or wireless networks, such as a wide area network (“WAN”), a local area network (“LAN”), personal area network (“PAN”), a cellular network (e.g., a 3G network, a 4G network, a 5G network, etc.) or the like. In some embodiments, the network 104 includes the Internet, and information and data provided between various systems occurs online. “Online” means connecting to or accessing source data or information from a location remote from other devices or networks coupled to the Internet. Alternatively, “online” refers to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The client device 102 and one or more of the server-side systems 106 are connected via the network 104, using one or more standard communication protocols. The client device 102 and the one or more of the server-side systems 106 transmit and receive communications from each other across the network 104.

Although depicted as separate components in FIG. 1, it should be understood that a component or portion of a component in the system of the environment 100 is, in some embodiments, integrated with or incorporated into one or more other components. As one example, the inconsistent data annotation identification system 112 and mitigation action system 114 can be integrated into a single component or sub-system of the data processing system 110. In some embodiments, operations or aspects of one or more of the components discussed above are distributed amongst one or more other components. Any suitable arrangement and/or integration of the various systems and devices of the environment 100 can be used.

In the following disclosure, various acts are described as performed or executed by a component represented in FIG. 1, such as the client device 102 or one or more of the server-side systems 106, or components thereof. However, it should be understood that in various aspects, various components of the environment 100 discussed above execute instructions or perform acts including the acts discussed below. An act performed by a device is considered to be performed by one or more processors, actuators, or the like associated with that device. Further, it should be understood that in various embodiments, various steps can be added, omitted, and/or rearranged in any suitable manner.

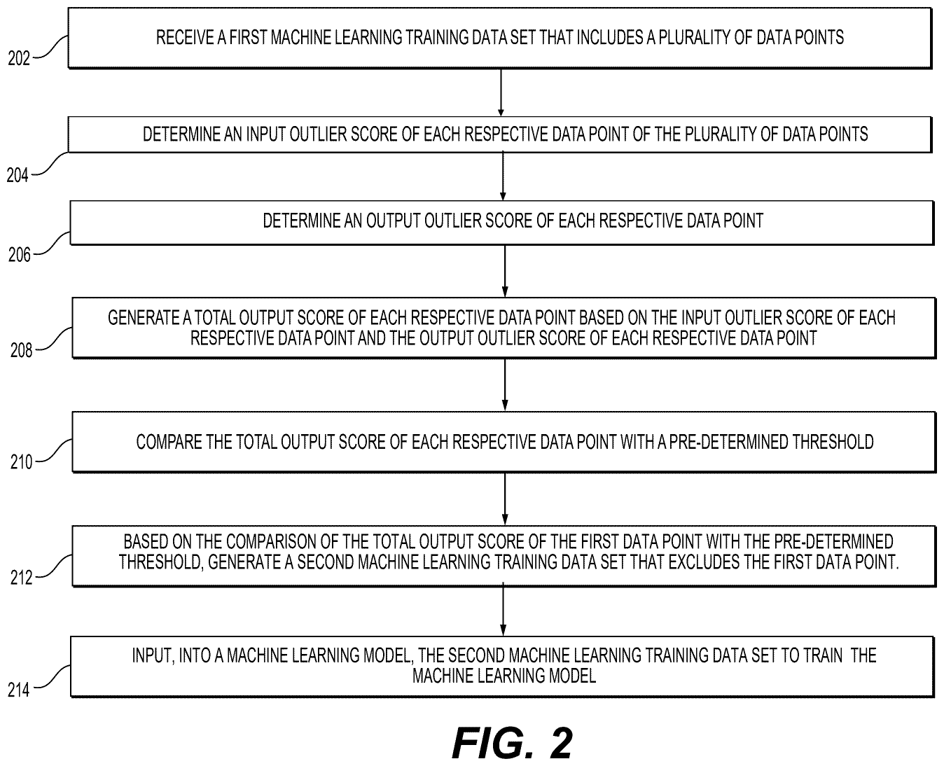

FIG. 2 is a flow chart showing an example of a process 200 for inconsistent data annotation identification and mitigation, according to some embodiments of the disclosure. In some examples, the process 200 is performed by the inconsistent data annotation identification system 112 and/or mitigation action system 114 of the data processing system 110. The process 200 can be performed in response to receiving a request to review data objects for inconsistent data annotations (e.g., from the client device 102).

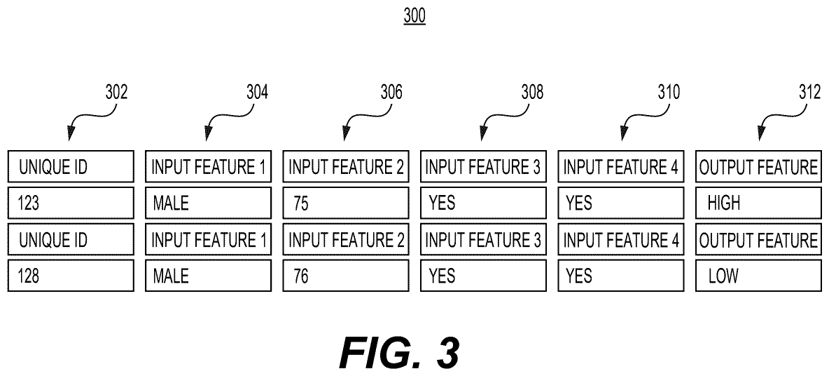

At step 202, process 200 includes receiving, at the data processing system 110, a first machine learning training data set that includes a plurality of data points. In some instances, the first machine learning training data set includes a series of input features associated with a set of data points, and an output label that classifies the data point based on the input features. In some examples, the first machine learning training data set is derived from a medical document that includes, as data points, a set of patients, and input features associated with each patient for the determination of an output lable, e.g., a risk of a specified ailment or disease. In FIG. 3, one such example document 300 is provided, where two patients listed in a medical document are described. In many examples, medical documents like the one described can include substantially more patients than the two described.

The document 300 includes an identification column 302 for a unique identifier (e.g., a patient ID), and four columns with input features. Column 304 provides an example of a binary input feature. Examples of binary input features include inputs that are true or false, 0 or 1, or in general, one of only two categories. Column 306 provides an example of an input feature that is numerical, e.g., the input feature is a number that is in at least a theoretically boundless range. Examples of numerical input features include height, weight, and age, where the data points are people, or price, cost, and depreciation in examples where the data points are commodities. Column 308 and column 310 are also binary input features, similar to column 304. Other types of input features, such as binary, text, or categorical are also acceptable inputs to the systems disclosed. e.g.

In some examples, document 300 is a medical document, where the data points are patients, and the input features are, e.g., gender, age, smoking status, and alcohol consumption status. Based on these four input features, in the example, an annotator, which may be a human operator or an algorithm, has determined an output feature, which is a risk status (e.g., risk for an ailment or disease) based on the four input features. The output feature 312 may be binary, e.g., the possible outputs are either “high” or “low,” or the output feature 312 may include more than two classes, e.g., “very low,” “low,” “medium,” “high,” and “very high.” In either binary or multi-class examples, there is an expectation that data points (e.g., patients) with similar input features have similar output features. In the example shown in FIG. 3, patient 123 is a 75-year old male patient who is a smoker and an alcoholic. This patient's risk for the ailment is determined to be high. Patient 128 is a 76-year old male who is also a smoker and an alcoholic. Patient 128 looks superficially very similar to patient 123, yet patient 123's risk for the ailment is determined to be low by the annotator.

Dissimilar labels such as these can arise due to aleatoric or epistemic uncertainties and do not necessarily reflect misclassifications. The annotated outputs may be accurate, but it remains beneficial to have them highlighted and assessed for better understanding of the dataset. Data points that do not follow the behaviors of other data points are often referred to as outliers.

At step 204, process 200 includes determining an input outlier score of each of the data points in the data set. In some embodiments, this determination is performed by the data processing system 110. Determining the input outlier score of a data point comprises: (i) determining a local outlier factor for the data point using a first k-nearest neighbor (KNN) algorithm; (ii) generating, based on the local outlier factor for the data point, a first value using a scaling function of the local outlier factor for the first data point; and (iii) equating the input outlier score of the first data point to the first value. In some embodiments, the first KNN algorithm is the Local Outlier Factor (LOF) algorithm that measures the local deviation of a given data point with respect to its neighbors within a data set. More precisely, locality of a given data point is given by its k-nearest neighbors, where k may be an arbitrary integer and the distances of the k-nearest neighbors are used to estimate the local density. By comparing the local density of a sample to the local densities of its neighbors, the propensity of each data point being a local outlier in the input space is determined.

The LOF algorithm generates a local outlier factor of approximately 1 for a data point consistent with its neighbors, a local outlier factor of less than 1 for data points even more densely clustered with its neighbors than average (an inlier, opposite of an outlier), and a local outlier factor of greater than 1 for a data point that is likely to be an outlier.

To represent the local outlier factors across data sets of multiple sample sizes and data variations, a scaling function may be used to represent all local outlier factors on a common scale. This is accomplished by generating, based on the local outlier factor for each respective data point, a first value using a scaling function of the local outlier factor for each data point; and equating the input outlier score of each data point to the first value. In some examples, the scaling function may be a min-max scaling function that produces a value between zero and one for each data point, where zero is the lowest score (data point with the smallest local outlier factor; e.g., most likely to be an inlier) for each data set and one is the highest score (data point with the largest local outlier factor; e.g., most likely to be an outlier) for each data set.

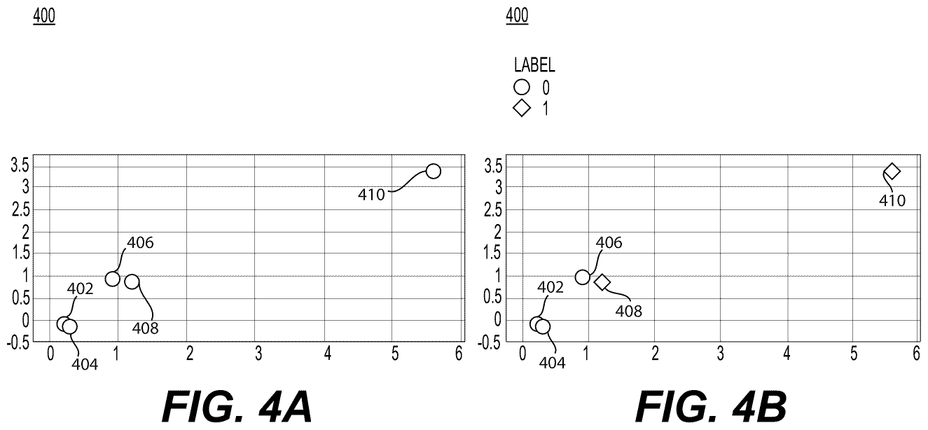

In another example shown in FIG. 4A, five data points are provided in another data set 400, with data points 402 and 404 situated closely together, data points 406 and 408 near each other, but not as near to each other as data points 402 and 404, and data point 410 distant from all of the other four data points. Applying the LOF algorithm to data set 400 yields results in a lowest local outlier factor for data point 404, and a highest local outlier factor for data point 410. As such, in the input space alone, data point 410 is identified as an outlier. However, further information is necessary to accurately determine whether data point 410 is incorrectly annotated. To determine whether data point 410 is correctly annotated includes, in at least some examples, further determining if data point 410 or any other data points in the data set are output outliers. This determination is described at step 206 with reference to FIG. 4B.

FIG. 4B includes the same data set 400 as FIG. 4A, with the addition of output labels added to the data points. In the example shown in FIG. 4B, the output labels are binary, comprising either a circle for output label 0 or a diamond for output label 1. Data points 402, 404, and 406 have been given output label 0 by an annotator (as represented by circles), and data points 408 and 410 have been given output label 1 by an annotator (as represented by diamonds).

At step 206, process 200 includes determining an output outlier score of each data point in the data set. In some embodiments, this determination is performed by the data processing system 110. Determining an output outlier score for a given data point includes, in some examples, incorporating a similarity metric to measure how similar two data points are. Additionally, the output labels of the data points are included to determine if two similar data points (in terms of input features) have been annotated to the same or different output classes. In some examples, step 206 includes (i) determining a centroid of a k-nearest neighborhood for each data point using a second KNN algorithm; (ii) calculating a Euclidean distance between the centroid and each data point; (iii) generating, based on the calculated Euclidean distance, a second value using a min-max scaling function of the calculated Euclidean distance; and (iv) equating the output outlier score of each respective data point to the second generated value.

In some examples, the output outlier score is calculated by first constructing a k-nearest neighborhood for each data point and then by comparing the output labels of the k-nearest neighbors with a target data point. As the output classes are categorical, the output outlier scores of each data point may be converted using one-hot encoding to be projected onto a Euclidean vector space. After the data points have been projected onto the Euclidean vector space, the centroid of the k-nearest neighbor in the Euclidean distance (in the output space) from the data point is calculated.

In the example shown in FIG. 4B, the 4-nearest neighbors of data point 408 includes data points 402, 404, 406 and data point 408 itself. Out of these four data points, three are from class 0 (data points 402, 404, and 406), and only one (data point 408 itself) is from class 1. Therefore, the centroid is [0.75, 0.25]. The Euclidean distance between the centroid and data point 408 is

$$\sqrt[2]{{( 0 - 0.75 )}^{2} + {( 1 - 0.25 )}^{2}} = 1.06 .$$

This is referred as the output outlier score for data point 408 for the value k=4 in the k-nearest neighbor algorithm.

As described above with reference to local outlier factors, to better represent the output outlier scores across data sets of multiple sample sizes and data variations, a scaling function may be used to represent all output outlier scores on a common scale. This is accomplished by generating, based on the output outlier scores for each respective data point, a first value using a scaling function of the local outlier factor for each data point; and equating the output outlier score of each data point to the first value. In some examples, the scaling function may be a min-max scaling function that produces a value between 0 and 1 for each data point, where 0 is the lowest score (data point with the smallest output outlier score; e.g., most likely to be an inlier) for each data set and 1 is the highest score (data point with the largest output outlier score; e.g., most likely to be an outlier) for each data set.

At step 208, process 200 includes generating a total output score of each respective data point in a data set based on the input outlier score of each respective data point and the output outlier score of each respective data point.

In Boolean logic, a correctly-annotated data point should have both a low input outlier score and a low output outlier score. An incorrectly annotated data point may be identified where there is a mismatch between input outlier score and outlier score, e.g., one is high while the other is low. A data point with both a high input outlier score and a high output outlier score is a total outlier and may be presented via a GUI for investigation, similar to a data point with an input outlier score and outlier score mismatch. To generate a single, total outlier score that factors both the input outlier score and the input outlier score, the following equation EQ may be used.

$$Total Outlier Score = 1 - ( 1 - Input Outlier Score ) \times Output Outlier Score . \qquad EQ 1$$

According to equation EQ1, a low final outlier score indicates a data point that has a different output class than its neighbors, e.g., a potentially incorrectly annotated data point. In some examples, generating a total output score includes applying a transformation to a total outlier score of a data point, where the transformation is configured to assign higher output scores to data points that have a greater likelihood of being inconsistently annotated data points and to assign lower output scores to data points that have a lower likelihood of being inconsistently annotated data points.

The following transformation EQ2 may be applied to assign higher output scores to potentially incorrectly annotated data points.

$$Total Output Score = 1 - Total Outlier Score . \qquad EQ2$$

Additionally, a Monte Carlo approximation may be used to make an outlier score invariant and independent of the number of neighbors chosen for each of the KNN algorithms. The total output score for a given data point may be made neighbor invariant based on equation EQ3:

$${\int }_{k = 2}^{∞} Total Output {Score}_{k} dk , \qquad EQ 3$$

EQ3 is the integral of the total output score over all possible values of k, the number of the neighbors. Using Monte Carlo approximation, the output score may be averaged over N trials for any number of k using equation EQ4:

$$\frac{1}{N} {\sum }_{k = 2}^{∞} Output {Score}_{k} \qquad EQ4$$

In EQ 4 above, N represents the number of trials.

At step 210, process 200 includes comparing the total output score for each of the data points with a pre-determined threshold. The pre-determined threshold may be dynamically set based on a learning model or may be set by a user based on a preference for sensitivity to false alarms. A relatively high threshold may yield less false alarms (correctly-annotated data points that are identified as potentially having an inconsistent annotation) but miss some inconsistent annotations, while a lower threshold is likely to identify all mislabeled annotations but identify some results that are correctly annotated as potentially being inconsistently-annotated.

At step 212, process 200 includes, based on the comparison of the total output score of the first data point with the pre-determined threshold, generating, by the one or more processors, a second machine learning training data set that excludes the first data point. In one embodiment, step 212 includes performing one of several mitigation actions. For example, the mitigation actions include: generating an alert indicating that a data point is an inconsistently annotated data point; or generating an updated data set with inconsistently annotated data points removed.

Examples of alerts include transmitting a signal to client device 102 to display a graphical alert on the client device 102, or may include generating the data set with the data points identified as possibly incorrectly annotated flagged, including graphical symbols such as exclamation points or question marks, or depicting the data points in a color easily identifiable to a user, such as red or yellow. The data set itself may include an alert that there may be incorrectly annotated data points within the data set, provided with, for example, a link to proceed to the specific data points that are identified as possible incorrect annotations.

At step 214, process 200 includes inputting into the machine learning model, the second machine learning training data set to train the machine learning model. The machine learning model trained by the second machine learning training data set can be a new model trained based on the training data set, or the model may be an already existing model that is fine-tuned by the input of the second machine learning training data set.

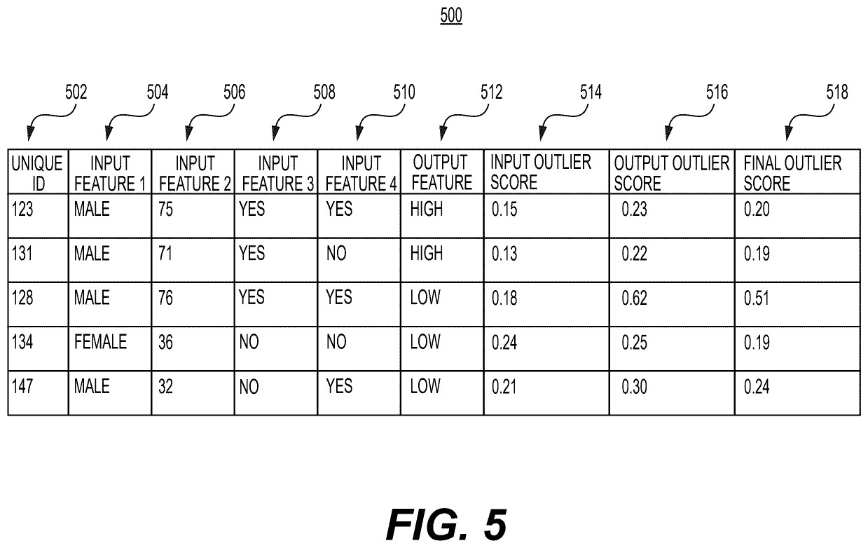

FIG. 5 depicts an example document demonstrating the use of process 200 described above. The document 500 includes an identification column 502 for a unique identifier (e.g., a patient ID), and four columns with input features. Column 504 provides an example of a binary input feature. Examples of binary input features include inputs that are true or false, 0 or 1, or in general, one of only two categories. Column 506 provides an example of an input feature that is numerical, e.g., the input feature is a number that is in at least a theoretically boundless range. Examples of numerical input features include height, weight, and age, where the data points are people, or price, cost, and depreciation in examples where the data points are commodities. Column 308 and column 310 are also binary input features, similar to column 304.

In some examples, document 500 is a medical document, where the data points are patients, and the input features are, e.g., gender, age, smoking status, and alcohol consumption status. Based on these four input features, in the example, an annotator, which may be a human operator or an algorithm, has determined an output feature, which is a risk status (e.g., risk for an ailment or disease) based on the four input features. The output feature 512 may be binary, e.g., the possible outputs are either “high” or “low,” or the output feature 512 may include more than two classes, e.g., “very low,” “low,” “medium,” “high,” and “very high.” In either binary or multi-class examples, there is an expectation that data points (e.g., patients) with similar input features have similar output features.

e.g.In the example shown in FIG. 5, like the example in FIG. 3, patient 123 is a 75-year old male patient who is a smoker and an alcoholic. This patient's risk for the ailment is determined to be high. Patient 128 is a 76-year old male who is also a smoker and an alcoholic. Patient 128 looks superficially very similar to patient 123, yet patient 123's risk for the ailment is determined to be low by the annotator.

FIG. 5 provides columns for input outlier score 514, output outlier score 516, and final outlier score 518. These additional columns highlight what was apparent but unquantified in medical document 300: that patient 128 is an outlier. Note that patient 128 has an input outlier score of 0.18, a lower input outlier score than patients 134 and 147. However, patient 123 has a high final outlier score 518 such that it may be observed that the output label for patient 123 may constitute an inconsistent annotation. All other annotations are correct and are not flagged by the inconsistent data annotation identification system 112.

In general, any process or operation discussed in this disclosure that is understood to be computer-implementable or described as computer-implemented can be performed by one or more processors of a computer system as described herein. A process or process step performed by one or more processors is also referred to as an operation. The one or more processors are configured to perform such processes by having access to instructions (e.g., software or computer-readable code) that, when executed by the one or more processors, cause the one or more processors to perform the processes. The instructions are stored in a memory of the computer system. A processor can be a central processing unit (CPU), a graphics processing unit (GPU), or any suitable types of processing unit.

A computer system, such as a system or device implementing a process or operation in the examples above, includes one or more computing devices. One or more processors of a computer system can be included in a single computing device or distributed among a plurality of computing devices. One or more processors of a computer system can be connected to a data storage device. A memory of the computer system includes the respective memory of each computing device of the plurality of computing devices.

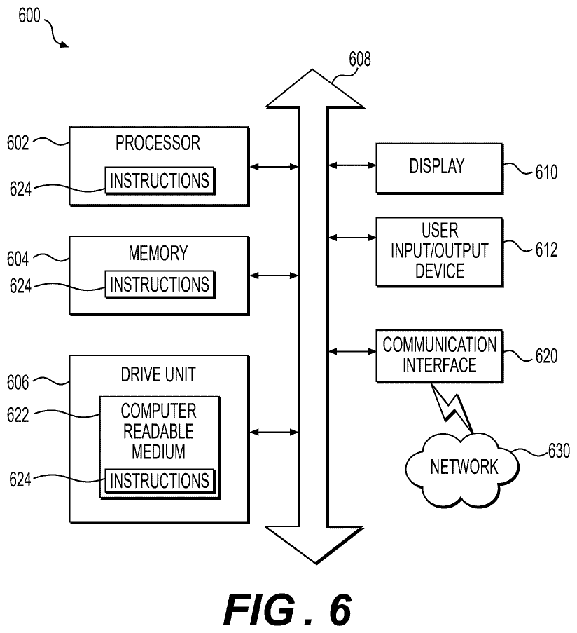

FIG 6 shows an implementation of a computer system 600 that executes techniques presented herein, according to some embodiments of the disclosure. The computer system 600 can include a set of instructions that can be executed to cause the computer system 600 to perform any one or more of the methods or computer-based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 can be implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG 6, the computer system 600 includes a processor 602, e.g., a central processing unit (CPU), a graphics processing unit (GPU), or both. The processor 602 can be a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (e.g., programmed).

The computer system 600 includes a memory 604 that can communicate via a bus 608. The memory 604 is a main memory, a static memory, or a dynamic memory. The memory 604 includes, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one implementation, the memory 604 includes a cache or random-access memory for the processor 602. In alternative implementations, the memory 604 is separate from the processor 602, such as a cache memory of a processor, the system memory, or other memory. The memory 604 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein are performed by the processor 602 executing the instructions stored in the memory 604. The functions, acts or tasks are independent of the particular type of instructions set, storage media, processor or processing strategy and are performed by software, hardware, integrated circuits, firm-ware, micro-code and the like, operating alone or in combination. Likewise, processing strategies can include multiprocessing, multitasking, parallel processing, and the like.

As shown, the computer system 600 further included a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in a drive unit 606.

Additionally or alternatively, the computer system 600 includes an input/output device 612 configured to allow a user to interact with any of the components of the computer system 600. The input/output device 612 is a number pad, a keyboard, or a cursor control device, such as a mouse, or a joystick, touch screen display, remote control, or any other device operative to interact with the computer system 600.

The computer system 600 also or alternatively includes the drive unit 606 implemented as a disk or optical drive. The drive unit 606 includes a computer-readable medium 622 in which one or more sets of instructions 624, e.g., software, can be embedded. Further, the sets of instructions 624 embody one or more of the methods or logic as described herein. The instructions 624 reside completely or partially within the memory 604 and/or within the processor 602 during execution by the computer system 600. The memory 604 and the processor 602 can also include computer-readable media as discussed above.

In some systems, the computer-readable medium 622 includes the sets of instructions 624 or receives and executes the sets of instructions 624 responsive to a propagated signal so that a device connected to a network 630 can communicate voice, video, audio, images, or any other data over the network 630. Further, the sets of instructions 624 are transmitted or received over the network 630 via a communication port or interface 620, and/or using the bus 608. The communication port or interface 620 is a part of the processor 602 or is a separate component. The communication port or interface 620 is created in software or is a physical connection in hardware. The communication port or interface 620 are configured to connect with the network 630, external media, the display 610, or any other components in the computer system 600, or combinations thereof. The connection with the network 630 is a physical connection, such as a wired Ethernet connection or is established wirelessly as discussed below. Likewise, the additional connections with other components of the computer system 600 are physical connections or are established wirelessly. The network 630 is alternatively directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that cause a computer system to perform any one or more of the methods or operations disclosed herein. In some examples, the computer-readable medium 622 is non-transitory, and is tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives are considered a distribution medium that is a tangible storage medium. Accordingly, the disclosure is considered to include any one or more of a computer-readable medium or a distribution medium and other equivalents and successor media, in which data or instructions are storable.

In an alternative implementation, dedicated hardware implementations, such as application specific integrated circuits, programmable logic arrays and other hardware devices, can be constructed to implement one or more of the methods described herein. Applications that include the apparatus and systems of various implementations can broadly include a variety of electronic and computer systems. One or more implementations described herein implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 600 is connected to the network 630. The network 630 defines one or more networks including wired or wireless networks, such as the network 104 described in FIG 1. The wireless network can be a cellular telephone network, an 602.11, 602.18, 602.20, or WiMAX network. Further, such networks include a public network, such as the Internet, a private network, such as an intranet, or combinations thereof, and utilize a variety of networking protocols now available or later developed including, but not limited to TCP/IP based networking protocols. The network 630 can include wide area networks (WAN), such as the Internet, local area networks (LAN), campus area networks, metropolitan area networks, a direct connection such as through a Universal Serial Bus (USB) port, or any other networks that allow for data communication. The network 630 is configured to couple one computing device to another computing device to enable communication of data between the devices. The network 630 generally is enabled to employ any form of machine-readable media for communicating information from one device to another. The network 630 includes communication methods by which information may travel between computing devices. The network 630 can be divided into sub-networks. The sub-networks allow access to all of the other components connected thereto or the sub-networks restrict access between the components. The network 630 can be regarded as a public or private network connection and can include, for example, a virtual private network or an encryption or other security mechanism employed over the public Internet, or the like.

In accordance with various implementations of the present disclosure, the methods described herein are implemented by software programs executable by a computer system. Further, in one example, non-limited implementation, implementations can include distributed processing, component/object distributed processing, and parallel processing. Alternatively, virtual computer system processing can be constructed to implement one or more of the methods or functionalities as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (e.g., computer) system executing instructions (computer-readable code) stored in storage. It will also be understood that the disclosure is not limited to any particular implementation or programming technique and that the disclosure is implementable using any appropriate techniques for implementing the functionality described herein. The disclosure is not limited to any particular programming language or operating system.

It should be appreciated that in the above description of example embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the methods and techniques described herein.

In the description provided herein, numerous specific details are set forth. However, it is understood that embodiments of the methods and techniques described can be practiced without these specific details. In other instances, well-known methods, structures, and techniques have not been shown in detail in order not to obscure an understanding of this description.

Thus, while there has been described what are believed to be the preferred embodiments, those skilled in the art will recognize that other and further modifications can be made thereto without departing from the spirit of the disclosure, and it is intended to claim all such changes and modifications as falling within the scope of the disclosure. For example, any formulas given above are merely representative of procedures that can be used. Functionality can be added or deleted from the block diagrams and operations are interchangeable among functional blocks. Steps can be added or deleted to methods described within the scope of the disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method for generating training data for a machine learning model, the computer-implemented method comprising: receiving, by one or more processors and from one or more data sources, a first machine learning training data set that includes a plurality of data points; determining, by the one or more processors, an input outlier score of a first data point of the plurality of data points; determining, by the one or more processors, an output outlier score of the first data point; generating, by the one or more processors, a total output score of the first data point based on the input outlier score of the first data point and the output outlier score of the first data point, the total output score of the first data point representing a likelihood that the first data point is an inconsistently annotated data point; comparing, by the one or more processors, the total output score of the first data point with a pre-determined threshold; based on the comparison of the total output score of the first data point with the pre-determined threshold, generating, by the one or more processors, a second machine learning training data set that excludes the first data point; and inputting, by the one or more processors and into the machine learning model, the second machine learning training data set to train the machine learning model.

Example 2. The computer-implemented method of example 1, wherein determining the input outlier score of the first data point of the plurality of data points comprises: determining, using the one or more processors, a local outlier factor for the first data point using a first k-nearest neighbor (KNN) algorithm; generating, using the one or more processors and based on the local outlier factor for the first data point, a first value using a scaling function of the local outlier factor for the first data point; and equating, using the one or more processors, the input outlier score of the first data point to the first value.

Example 3. The computer-implemented method of any of examples 1-2, wherein determining the output outlier score of the first data point of the plurality of data points comprises: determining, using the one or more processors, a centroid of a k-nearest neighborhood for the first data point using a second KNN algorithm; calculating, using the one or more processors, a Euclidean distance between the centroid and the first data point; generating, using the one or more processors and based on the calculated Euclidean distance, a second value between zero and one using a min-max scaling function of the calculated Euclidean distance; and equating, using the one or more processors, the output outlier score of the first data point to the second generated value.

Example 4. The computer-implemented method of any of examples 1-3, wherein generating the total output score of the first data point of the plurality of data points comprises: applying, using the one or more processors, a transformation to a total outlier score of the first data point, wherein the transformation assigns higher output scores to data points that have a greater likelihood of being inconsistently annotated data points and assigns lower output scores to data points that have a lower likelihood of being inconsistently annotated data points.

Example 5. The computer-implemented method of any of examples 1-4, wherein: determining the input outlier score of the first data point includes applying, using the one or more processors, a first KNN algorithm; determining the output outlier score of the first data point includes applying, using the one or more processors, a second KNN algorithm; and generating the total output score of the first data point of the plurality of data points comprises applying, using the one or more processors, a Monte Carlo approximation to the first KNN algorithm and to the second KNN algorithm.

Example 6. The computer-implemented method of any of examples 1-5, further comprising: determining, by the one or more processors, an input outlier score of a second data point of the plurality of data points; determining, by the one or more processors, an output outlier score of the second data point; generating, by the one or more processors, a total output score of the second data point based on the input outlier score of the second data point and the output outlier score of the second data point, the total output score of the second data point representing a likelihood that the second data point is an inconsistently annotated data point; comparing, by the one or more processors, the total output score of the second data point with the pre-determined threshold; based on the comparison of the total output score of the second data point with the pre-determined threshold, generating, by the one or more processors, a third machine learning training data set that excludes the second data point; and inputting, by the one or more processors and into the machine learning model, the third machine learning training data set to train the machine learning model.

Example 7. The computer-implemented method of any of examples 1-6, further comprising: based on the comparison of the total output score of the first data point with the pre-determined threshold, generating, by the one or more processors, an alert indicating that the first data point is an inconsistently annotated data point.

Example 8. A system for generating training data for a machine learning model, the system comprising: one or more processors of a computing system; and at least one non-transitory computer readable medium storing instructions which, when executed by the one or more processors, cause the one or more processors to: receive, from one or more data sources, a first machine learning training data set that includes a plurality of data points; determine an input outlier score of a first data point of the plurality of data points; determine an output outlier score of the first data point; generate a total output score of the first data point based on the input outlier score of the first data point and the output outlier score of the first data point, the total output score of the first data point representing a likelihood that the first data point is an inconsistently annotated data point; compare the total output score of the first data point with a pre-determined threshold; based on the comparison of the total output score of the first data point with the pre-determined threshold, generate a second machine learning training data set that excludes the first data point; and input, into the machine learning model, the second machine learning training data set to train the machine learning model.

Example 9. The system of example 8, wherein determining the input outlier score of the first data point of the plurality of data points comprises: determining a local outlier factor for the first data point using a first k-nearest neighbor (KNN) algorithm; generating, based on the local outlier factor for the first data point, a first value using a scaling function of the local outlier factor for the first data point; and equating the input outlier score of the first data point to the first value.

Example 10. The system of any of examples 8-9, wherein determining the output outlier score of the first data point of the plurality of data points comprises: determining a centroid of a k-nearest neighborhood for the first data point using a second KNN algorithm; calculating a Euclidean distance between the centroid and the first data point; generating, based on the calculated Euclidean distance, a second value between zero and one using a min-max scaling function of the calculated Euclidean distance; and equating the output outlier score of the first data point to the second generated value.

Example 11. The system of any of examples 8-10, wherein generating the total output score of the first data point of the plurality of data points comprises: applying a transformation to a total outlier score of the first data point, wherein the transformation assigns higher output scores to data points that have a greater likelihood of being inconsistently annotated data points and to assign lower output scores to data points that have a lower likelihood of being inconsistently annotated data points.

Example 12. The system of any of examples 8-11, wherein: determining the input outlier score of the first data point includes applying a first KNN algorithm; determining the output outlier score of the first data point includes applying a second KNN algorithm; generating the total output score of the first data point of the plurality of data points comprises applying a Monte Carlo approximation to the first KNN algorithm and to the second KNN algorithm.

Example 13. The system of any of examples 8-12, wherein the instructions further cause the one or more processors to: determine an input outlier score of a second data point of the plurality of data points; determine an output outlier score of the second data point; generate a total output score of the second data point based on the input outlier score of the second data point and the output outlier score of the second data point, the total output score of the second data point representing a likelihood that the second data point is an inconsistently annotated data point; compare the total output score of the second data point with the pre-determined threshold; based on the comparison of the total output score of the second data point with the pre-determined threshold, generate a third machine learning training data set that excludes the second data point; and input, into the machine learning model, the third machine learning training data set to train the machine learning model.

Example 14. The system of any of examples 8-13, wherein the instructions further cause the one or more processors to: based on the comparison of the total output score of the first data point with the pre-determined threshold, generate an alert indicating that the first data point is an inconsistently annotated data point.

Example 15. A non-transitory computer readable medium for generating training data for a machine learning model, the non-transitory computer readable medium storing instructions which, when executed by one or more processors of a computing system, cause the one or more processors to: receive, from one or more data sources, a first machine learning training data set that includes a plurality of data points; determine an input outlier score of a first data point of the plurality of data points; determine an output outlier score of the first data point; generate a total output score of the first data point based on the input outlier score of the first data point and the output outlier score of the first data point, the total output score of the first data point representing a likelihood that the first data point is an inconsistently annotated data point; compare the total output score of the first data point with a pre-determined threshold; based on the comparison of the total output score of the first data point with the pre-determined threshold, generate a second machine learning training data set that excludes the first data point; and input, into the machine learning model, the second machine learning training data set to train the machine learning model.

Example 16. The non-transitory computer readable medium of example 15, wherein determining the input outlier score of the first data point of the plurality of data points comprises: determining a local outlier factor for the first data point using a first k-nearest neighbor (KNN) algorithm; generating, based on the local outlier factor for the first data point, a first value using a scaling function of the local outlier factor for the first data point; and equating the input outlier score of the first data point to the first value.

Example 17. The non-transitory computer readable medium of any of examples 15-16, wherein determining the output outlier score of the first data point of the plurality of data points comprises: determining a centroid of a k-nearest neighborhood for the first data point using a second KNN algorithm; calculating a Euclidean distance between the centroid and the first data point; generating, based on the calculated Euclidean distance, a second value between zero and one using a min-max scaling function of the calculated Euclidean distance; and equating the output outlier score of the first data point to the second generated value.

Example 18. The non-transitory computer readable medium of any of examples 15-17, wherein generating the total output score of the first data point of the plurality of data points comprises: applying a transformation to a total outlier score of the first data point, wherein the transformation assigns higher output scores to data points that have a greater likelihood of being inconsistently annotated data points and assigns lower output scores to data points that have a lower likelihood of being inconsistently annotated data points.

Example 19. The non-transitory computer readable medium of any of examples 15-18, wherein: determining the input outlier score of the first data point includes applying a first KNN algorithm; determining the output outlier score of the first data point includes applying a second KNN algorithm; generating the total output score of the first data point of the plurality of data points comprises applying a Monte Carlo approximation to the first KNN algorithm and to the second KNN algorithm.

Example 20. The non-transitory computer readable medium of any of examples 15-19, wherein the instructions further cause the one or more processors to: determine an input outlier score of a second data point of the plurality of data points; determine an output outlier score of the second data point; generate a total output score of the second data point based on the input outlier score of the second data point and the output outlier score of the second data point, the total output score of the second data point representing a likelihood that the second data point is an inconsistently annotated data point; compare the total output score of the second data point with the pre-determined threshold; based on the comparison of the total output score of the second data point with the pre-determined threshold, generate a third machine learning training data set that excludes the second data point; and input, into the machine learning model, the third machine learning training data set to train the machine learning model.

1. A computer-implemented method for generating training data for a machine learning model, the computer-implemented method comprising:
receiving, by one or more processors and from one or more data sources, a first machine learning training data set that includes a plurality of data points;
determining, by the one or more processors, an input outlier score of a first data point of the plurality of data points;
determining, by the one or more processors, an output outlier score of the first data point;
generating, by the one or more processors, a total output score of the first data point based on the input outlier score of the first data point and the output outlier score of the first data point, the total output score of the first data point representing a likelihood that the first data point is an inconsistently annotated data point;
comparing, by the one or more processors, the total output score of the first data point with a pre-determined threshold;
based on the comparison of the total output score of the first data point with the pre-determined threshold, generating, by the one or more processors, a second machine learning training data set that excludes the first data point; and
inputting, by the one or more processors and into the machine learning model, the second machine learning training data set to train the machine learning model.

2. The computer-implemented method of claim 1, wherein determining the input outlier score of the first data point of the plurality of data points comprises:
determining, using the one or more processors, a local outlier factor for the first data point using a first k-nearest neighbor (KNN) algorithm;
generating, using the one or more processors and based on the local outlier factor for the first data point, a first value using a scaling function of the local outlier factor for the first data point; and
equating, using the one or more processors, the input outlier score of the first data point to the first value.

3. The computer-implemented method of claim 1, wherein determining the output outlier score of the first data point of the plurality of data points comprises:
determining, using the one or more processors, a centroid of a k-nearest neighborhood for the first data point using a second KNN algorithm;
calculating, using the one or more processors, a Euclidean distance between the centroid and the first data point;
generating, using the one or more processors and based on the calculated Euclidean distance, a second value between zero and one using a min-max scaling function of the calculated Euclidean distance; and
equating, using the one or more processors, the output outlier score of the first data point to the second generated value.

4. The computer-implemented method of claim 1, wherein generating the total output score of the first data point of the plurality of data points comprises:
applying, using the one or more processors, a transformation to a total outlier score of the first data point, wherein the transformation assigns higher output scores to data points that have a greater likelihood of being inconsistently annotated data points and assigns lower output scores to data points that have a lower likelihood of being inconsistently annotated data points.

5. The computer-implemented method of claim 1, wherein:
determining the input outlier score of the first data point includes applying, using the one or more processors, a first KNN algorithm;
determining the output outlier score of the first data point includes applying, using the one or more processors, a second KNN algorithm; and
generating the total output score of the first data point of the plurality of data points comprises applying, using the one or more processors, a Monte Carlo approximation to the first KNN algorithm and to the second KNN algorithm.

6. The computer-implemented method of claim 1, further comprising:
determining, by the one or more processors, an input outlier score of a second data point of the plurality of data points;
determining, by the one or more processors, an output outlier score of the second data point;
generating, by the one or more processors, a total output score of the second data point based on the input outlier score of the second data point and the output outlier score of the second data point, the total output score of the second data point representing a likelihood that the second data point is an inconsistently annotated data point;
comparing, by the one or more processors, the total output score of the second data point with the pre-determined threshold;
based on the comparison of the total output score of the second data point with the pre-determined threshold, generating, by the one or more processors, a third machine learning training data set that excludes the second data point; and
inputting, by the one or more processors and into the machine learning model, the third machine learning training data set to train the machine learning model.

7. The computer-implemented method of claim 1, further comprising:
based on the comparison of the total output score of the first data point with the pre-determined threshold, generating, by the one or more processors, an alert indicating that the first data point is an inconsistently annotated data point.

8. A system for generating training data for a machine learning model, the system comprising:
one or more processors of a computing system; and
at least one non-transitory computer readable medium storing instructions which, when executed by the one or more processors, cause the one or more processors to:
receive, from one or more data sources, a first machine learning training data set that includes a plurality of data points;
determine an input outlier score of a first data point of the plurality of data points;
determine an output outlier score of the first data point;
generate a total output score of the first data point based on the input outlier score of the first data point and the output outlier score of the first data point, the total output score of the first data point representing a likelihood that the first data point is an inconsistently annotated data point;
compare the total output score of the first data point with a pre-determined threshold;
based on the comparison of the total output score of the first data point with the pre-determined threshold, generate a second machine learning training data set that excludes the first data point; and
input, into the machine learning model, the second machine learning training data set to train the machine learning model.

9. The system of claim 8, wherein determining the input outlier score of the first data point of the plurality of data points comprises:
determining a local outlier factor for the first data point using a first k-nearest neighbor (KNN) algorithm;
generating, based on the local outlier factor for the first data point, a first value using a scaling function of the local outlier factor for the first data point; and
equating the input outlier score of the first data point to the first value.

10. The system of claim 8, wherein determining the output outlier score of the first data point of the plurality of data points comprises:
determining a centroid of a k-nearest neighborhood for the first data point using a second KNN algorithm;
calculating a Euclidean distance between the centroid and the first data point;
generating, based on the calculated Euclidean distance, a second value between zero and one using a min-max scaling function of the calculated Euclidean distance; and
equating the output outlier score of the first data point to the second generated value.

11. The system of claim 8, wherein generating the total output score of the first data point of the plurality of data points comprises:
applying a transformation to a total outlier score of the first data point, wherein the transformation assigns higher output scores to data points that have a greater likelihood of being inconsistently annotated data points and to assign lower output scores to data points that have a lower likelihood of being inconsistently annotated data points.

12. The system of claim 8, wherein:
determining the input outlier score of the first data point includes applying a first KNN algorithm;
determining the output outlier score of the first data point includes applying a second KNN algorithm;
generating the total output score of the first data point of the plurality of data points comprises applying a Monte Carlo approximation to the first KNN algorithm and to the second KNN algorithm.

13. The system of claim 8, wherein the instructions further cause the one or more processors to:
determine an input outlier score of a second data point of the plurality of data points;
determine an output outlier score of the second data point;
generate a total output score of the second data point based on the input outlier score of the second data point and the output outlier score of the second data point, the total output score of the second data point representing a likelihood that the second data point is an inconsistently annotated data point;
compare the total output score of the second data point with the pre-determined threshold;
based on the comparison of the total output score of the second data point with the pre-determined threshold, generate a third machine learning training data set that excludes the second data point; and
input, into the machine learning model, the third machine learning training data set to train the machine learning model.

14. The system of claim 8, wherein the instructions further cause the one or more processors to:
based on the comparison of the total output score of the first data point with the pre-determined threshold, generate an alert indicating that the first data point is an inconsistently annotated data point.

15. A non-transitory computer readable medium for generating training data for a machine learning model, the non-transitory computer readable medium storing instructions which, when executed by one or more processors of a computing system, cause the one or more processors to:
receive, from one or more data sources, a first machine learning training data set that includes a plurality of data points;
determine an input outlier score of a first data point of the plurality of data points;
determine an output outlier score of the first data point;
generate a total output score of the first data point based on the input outlier score of the first data point and the output outlier score of the first data point, the total output score of the first data point representing a likelihood that the first data point is an inconsistently annotated data point;
compare the total output score of the first data point with a pre-determined threshold;
based on the comparison of the total output score of the first data point with the pre-determined threshold, generate a second machine learning training data set that excludes the first data point; and
input, into the machine learning model, the second machine learning training data set to train the machine learning model.

16. The non-transitory computer readable medium of claim 15, wherein determining the input outlier score of the first data point of the plurality of data points comprises:
determining a local outlier factor for the first data point using a first k-nearest neighbor (KNN) algorithm;
generating, based on the local outlier factor for the first data point, a first value using a scaling function of the local outlier factor for the first data point; and
equating the input outlier score of the first data point to the first value.

17. The non-transitory computer readable medium of claim 15, wherein determining the output outlier score of the first data point of the plurality of data points comprises:
determining a centroid of a k-nearest neighborhood for the first data point using a second KNN algorithm;
calculating a Euclidean distance between the centroid and the first data point;
generating, based on the calculated Euclidean distance, a second value between zero and one using a min-max scaling function of the calculated Euclidean distance; and
equating the output outlier score of the first data point to the second generated value.

18. The non-transitory computer readable medium of claim 15, wherein generating the total output score of the first data point of the plurality of data points comprises:
applying a transformation to a total outlier score of the first data point, wherein the transformation assigns higher output scores to data points that have a greater likelihood of being inconsistently annotated data points and assigns lower output scores to data points that have a lower likelihood of being inconsistently annotated data points.

19. The non-transitory computer readable medium of claim 15, wherein:
determining the input outlier score of the first data point includes applying a first KNN algorithm;
determining the output outlier score of the first data point includes applying a second KNN algorithm;
generating the total output score of the first data point of the plurality of data points comprises applying a Monte Carlo approximation to the first KNN algorithm and to the second KNN algorithm.

20. The non-transitory computer readable medium of claim 15, wherein the instructions further cause the one or more processors to:
determine an input outlier score of a second data point of the plurality of data points;
determine an output outlier score of the second data point;
generate a total output score of the second data point based on the input outlier score of the second data point and the output outlier score of the second data point, the total output score of the second data point representing a likelihood that the second data point is an inconsistently annotated data point;
compare the total output score of the second data point with the pre-determined threshold;
based on the comparison of the total output score of the second data point with the pre-determined threshold, generate a third machine learning training data set that excludes the second data point; and
input, into the machine learning model, the third machine learning training data set to train the machine learning model.
